(19) United States
(12) Patent Application Publication
(10) Pub. No.: US 2009/0150862 A1
(43) Pub. Date: Jun. 11, 2009

(54) USER-SPECIFIED SEMANTICS FOR PARALLEL OPERATIONS WITH A TIME-EXPLICIT PROGRAMMING LANGUAGE

(75) Inventor: Bruce Hamilton, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/953,269

(22) Filed: Dec. 10, 2007

(51) Int. Cl. G06F 9/44

(52) U.S. Cl. 717/106

(57) ABSTRACT

In a computer programming language environment wherein operations are specified in one or more parallel frame sequences of frames arranged on a time scale, a programming language provides user-specifiable semantics for defining the start times for starting the frames and the end times for ending the frames. A method may be executed according to a routine constructed using the programming language, wherein the method includes providing user-specified semantics for defining the start times for starting the frames and for defining the end times for ending the frames, and executing operations according to the start times and end times for the frames as defined by the user-specified semantics.

### BACKGROUND

Most known existing computer programming and other machine-control languages and associated systems do not allow a programmer to specify an explicit or absolute time-of-day within the programming language. Instead, they deal with time implicitly. For example, they provide the ability to trigger an event “now,” or in relationship to when another event occurs (e.g.: “when a pulse appears on the ‘Sync IN’ connector;” “two clock cycles after a FLAG is set;” or “250 microseconds after you get this message;” etc.).

More generally, in these existing languages, the intended time for the event cannot be stated explicitly. Since the time of an event can only be specified as an offset from another event, it is not possible to specify that an event is to be triggered at, say, 3:01 PM on 8 Jun. 2015. More specifically, when a plurality of operations are to be performed in some sense “in parallel” these existing languages and systems are quite constrained in the way in which “in parallel” can be interpreted.

These are considered to be “facts of life” in existing programming languages, and are thus not considered “problems.” Thus, in these languages, no solutions exist.

For these reasons, in general there has been no effort to specify the exact semantics for executing parallel operations in a time-explicit environment, i.e., exactly what is supposed to happen when two or more operations are to be performed in some sense “in parallel,” or in some time-dependency relationship, in a language and environment where time can be expressed explicitly.

However, this lack of expressive power is a weakness. If programs could specify those things and run-time environments could implement them, programmers could state their intent more directly and clearly, and their programs would be easier to debug and maintain.

What is needed, therefore, is a method of specifying the semantics for parallel operations in a time-explicit programming language. What is also needed is such a means for specifying such semantics for a programming language that allows a user to specify timing and synchronization relationships of operations using a high-level graphical specification.

### SUMMARY

In an example embodiment, in a computer programming language environment wherein operations are specified in one or more parallel sequences of frames arranged on a time scale, a programmer is allowed to provide semantics for the indicated start times for starting the frames and the relationship among the start times of different frames, and the exact behavior of those frames with respect to those start times. The programmer is also allowed to provide semantics for the indicated end times for ending the frames, and the exact behavior of those frames with respect to those end times. Operations are executed according to the start times and end times for the frames and the behavior as specified by the programmer-supplied semantics.

In another example embodiment, a computer-based system, comprises: memory; and a processor configured to execute one or more algorithms in response to instructions stored in the memory and written using a programming language, the programming language further providing programmer-specified semantics for defining start times for starting the frames and programmer-specified semantics for defining end times for ending the frames, wherein the processor executes the operations according to start times and end times for the frames according to the programmer-specified semantics.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a diagram illustrating one embodiment of a system that may execute an algorithm according to instructions written using a computer programming language that allows a user to specify timing and synchronization relationships of operations using a high-level graphical specification.

FIG. 2 is a more detailed function block diagram of one embodiment of a device that may be employed in the system of FIG. 1.

FIG. 3 shows a construct of parallel frame sequences for specifying operations of a software algorithm.

FIG. 4 illustrates an option tree for specifying a starting relationship between two frames in the construct of FIG. 3.

FIG. 5 illustrates an option tree for specifying an ending relationship between two frames in the construct of FIG. 3.

FIG. 6 illustrates an option tree for specifying the end of a frame in the construct of FIG. 3.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

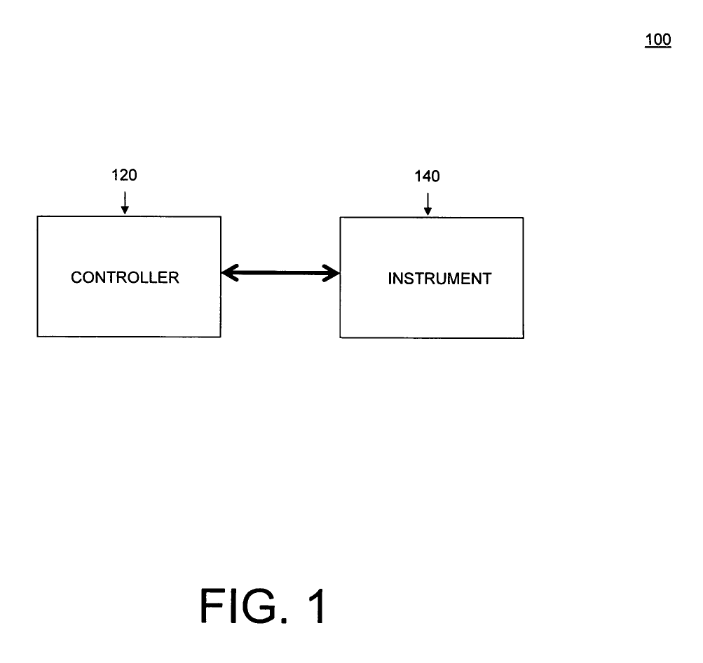

FIG. 1 is a diagram illustrating one embodiment of a system that may execute an algorithm according to instructions written using a computer programming language that allows a user to specify timing and synchronization relationships of operations using a high-level graphical specification.

The system 100 includes a controller 120 and an instrument 140. It is important to note that FIG. 1 is only one exemplary embodiment that will be used in the discussion to follow to better illustrate various aspects of a computer programming language that allows a user to specify timing and synchronization relationships of operations using a high-level graphical specification. For example, the method and system can also be employed in an embodiment where a single standalone computer processor (e.g., a personal computer) executes various software routines employing a computer programming language that allows a user to specify timing and synchronization relationships of operations using a high-level graphical specification.

In the system 100, controller 120 monitors and/or controls instrument 140.

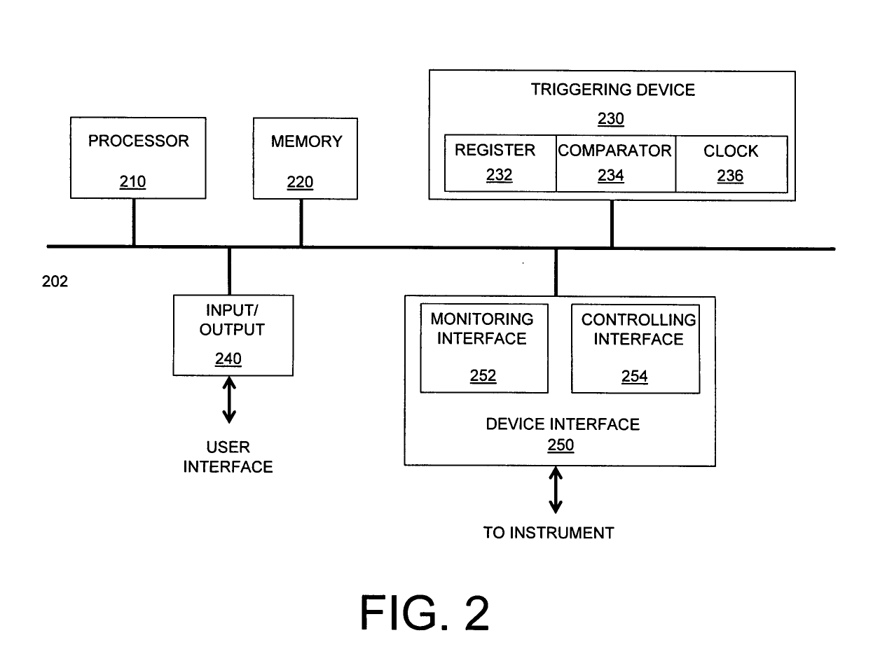

FIG. 2 is a more detailed function block diagram of one embodiment of a controller 120 that may be employed in the system of FIG. 1.

Controller 120 includes processor 210, memory 220, triggering device 230, input/output (I/O) connection 240, and device interface 250, all connected by a data bus 202. Triggering device 230 includes comparator 234, register 232, and real-time clock 236. Device interface 250 includes monitoring interface 252 and controlling interface 254. Again, the embodiment of FIG. 2 is only one exemplary embodiment that will be used in the discussion to follow to better illustrate various aspects of a method and system providing semantic choices for a computer programming language that allows a user to specify timing and synchronization relationships of operations using a high-level graphical specification. In other embodiments, various elements may be omitted, particularly device interface 250.

In operation, memory 220 stores executable code in designated memory locations. Processor 210 executes a software algorithm in accordance with the machine code stored in memory 220. The software algorithm executes instructions provided in a programming language used to construct the software algorithm. As described in more detail below, the programming language is configured to allow a user to specify timing and synchronization relationships of operations using a high-level graphical specification. In one embodiment, the programming language is configured to operate with real-time clock 236, and provides the ability to specify that an action is to be performed at an explicit time. In that regard, triggering device 230 employs real-time clock 236 to provide a running update of absolute time. In that case, when executing an instruction to schedule an action to be performed at an explicit time, the scheduled time, TS, for the action to be performed is loaded into register 232. Comparator 234 compares the clock time from clock 236, TCLOCK, against the scheduled time TS stored in register 232, and when the times are the same, then comparator 234 generates a hardware trigger signal (an edge, typically) and sends the trigger signal to the circuit to be activated. For example, where the action is to be performed by instrument 140 of FIG. 1, then the trigger signal for the action may be provided to device interface 250). In that case, driver interface 250 may pass the trigger signal across controlling interface 254 to instrument 140 for the action to be performed.

In practice, clock 236 advances at the granularity of the underlying crystal, so the scheduled time stored in register 232, TS, may fall between “ticks.” Thus, it is necessary for comparator 234 to check if the clock time from clock 236, TCLOCK>TS, the scheduled time, rather than merely checking to see if the TCLOCK=TS. That means, however, that once the scheduled time TS is reached, comparator 236 will generate the hardware trigger signal on every subsequent clock tick. This is not what was intended. To address this issue, additional circuitry (not shown) is employed to make the action occur only once. One embodiment uses the output of the comparison to turn off an “enable bit” that causes the comparison to occur. In another embodiment, the circuit implements a small state machine, and outputs an edge if the TCLOCK<TS, on one clock tick and TCLOCK>TS, on the next clock tick.

U.S. patent application Ser. No. 11/429,981 of Stanley T. Jefferson et al., (Attorney Docket 10060137) filed on 8 May 2006, the contents of which are incorporated herein by reference, describes aspects of a programming language that allows a user to specify timing and synchronization relationships of operations in a processor-executed algorithm using a high-level graphical specification. In particular, Jefferson describes a construct that allows a programmer to specify that certain operations are intended to occur in some sense in parallel by placing them in vertical alignment on a horizontal time scale. The construct also allows a programmer to specify that other operations are intended to occur in some sense sequentially by arranging them horizontally on the time scale.

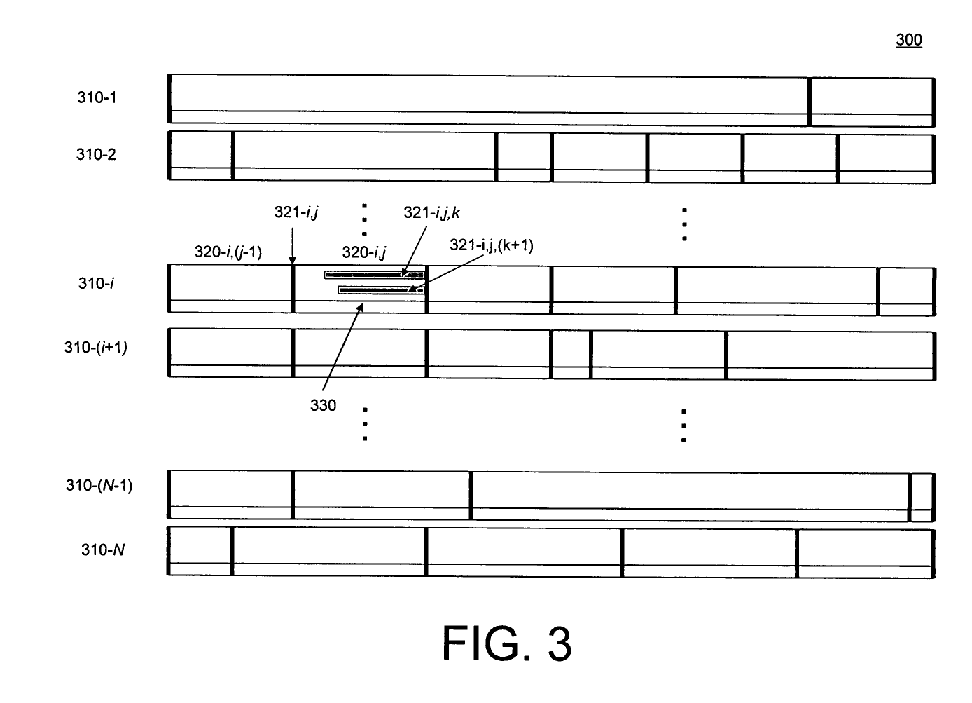

FIG. 3 shows a construct 300 of parallel frame sequences 310-i for specifying operations of a software algorithm. In one embodiment, a programming language employs the construct 300 to allow a programmer to create a set of instructions which may be executed by a processor to perform a desired algorithm. Each frame sequence 310-i may include a plurality of frames 320-i,j each of which has a synchronization edge 321-i,j defining its start. Each frame 320-i,j may further include frame elements 322-i,j,k. Element 330 denotes a region where a start time and a duration may be input by a programmer.

A frame sequence 310-i may include an arbitrary number of frames 320-i,j. A frame 320-i may include zero, one, two or more frame elements 322-i,j,k. Each frame element 322-i,j,k may represent a computation, event, action or other operation. In one embodiment, a frame element 322-i,j,k may be an “embedded” frame sequence 310.

A programming language employing the construct 300 presents a cleaner and more intuitive of specifying time-aware parallel operations than conventional textual and data-flow programming languages.

Once time and parallelism of operations can be specified in this way, certain semantic issues arise concerning what is meant by a particular two-dimensional arrangement of operations. If certain questions are not explicitly addressed, then the programming language would be semantically ambiguous. In other words, there would be more than one possible meaning for a given two-dimensional arrangement of operations. If these questions are explicitly addressed via a single, predetermined answer, then the programming language can be made semantically unambiguous, but would be constrained and lacking in expressive power.

Therefore, in one embodiment, a set of semantic choices is provided for answering certain questions in a programming language environment wherein operations are specified in one or more parallel frame sequences of frames arranged on a time scale

These questions can be grouped into at least three categories: (1) when does a frame start; (2) when does a frame end; and (3) when does a parallel group of frames or frame events end?

Turning first to the first category, in one embodiment, semantic choices are provided for a programming language for defining the start times for starting frames in a construct such as the construct 300 of FIG. 3.

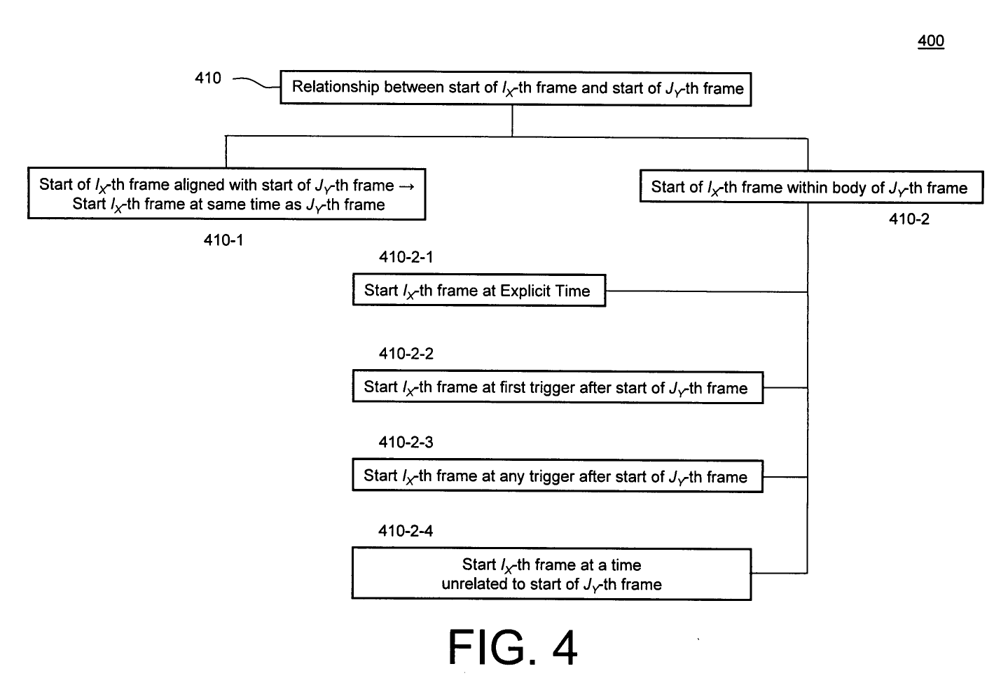

FIG. 4 illustrates an option tree 400 for specifying a starting relationship between two frames in the construct of FIG. 3. The trunk 410 of tree 400 is the relationship between the start of an I_{X}-th frame of an X-th frame sequence and the start of a J_{Y}-th frame in a Y-th frame sequence. Each of the branches in FIG. 4 can be viewed as one optional meaning for that relationship.

A first upper-level branch 410-1 corresponds to a graphical relationship where the start of an I_{X}-th frame of an X-th frame sequence is aligned with a start time of a J_{Y}-th frame in a Y-th frame sequence. In that case, the semantics are simple: the I_{X}-th frame and the J_{Y}-th frame start at the same time.

A second upper-level branch 410-2 corresponds to a graphical relationship where the start of the I_{X}-th frame lies between the start time and the end time of a J_{Y}-th frame.

In the second upper-level branch 410-2, several lower level branches exist. Each of these lower level branches can be viewed as one optional meaning for a graphical relationship wherein the start of the I_{X}-th frame lies between the start time and the end time of a J_{Y}-th frame.

In one lower level branch 410-2-1, the I_{X}-th frame is meant to start at a particular time. In that case, for example, a compiler for the programming language checks that the time lies within the times defined by the body of the J_{Y}-th frame and the executable instructions then start the I_{X}-th frame at that time.

In another lower level branch 410-2-2, the I_{X}-th frame is meant to start the first time that a specified start condition occurs after the start of the J_{Y}-th frame.

In still another lower level branch 410-2-3, the I_{X}-th frame is meant to start anytime that a specified start condition occurs after the start of the J_{Y}-th frame.

In yet another lower level branch 410-2-4, the start of the I_{X}-th frame falling within the within the body of J_{Y}-th frame is a mere happenstance. That is, the start of the I_{X}-th frame is unrelated to the start of the J_{Y}-th frame. For example, the I_{X}-th frame may comprise an operation that is not time-oriented.

In one embodiment, a user is allowed to specify any of the meanings identified by the branches in FIG. 4. For example, the programming language may allow a programmer to designate the meaning associated with lower level branch 410-2-1 by marking the left edge (i.e., synchronization edge 321) with an explicit time. The programming language may further allow a programmer to designate the meaning associated with lower level branch 410-2-2 by default.

Also, in the case of lower level branches 410-2-2 and 410-2-3, it can be seen from FIG. 3 that the left edge of the I_{X}-th frame may occur within the body of different frames 320 in several of the thread sequences 310. In that case, a programmer may specify that the J_{Y}-th frame is the intended frame on which the start of the I_{X}-th frame depends.

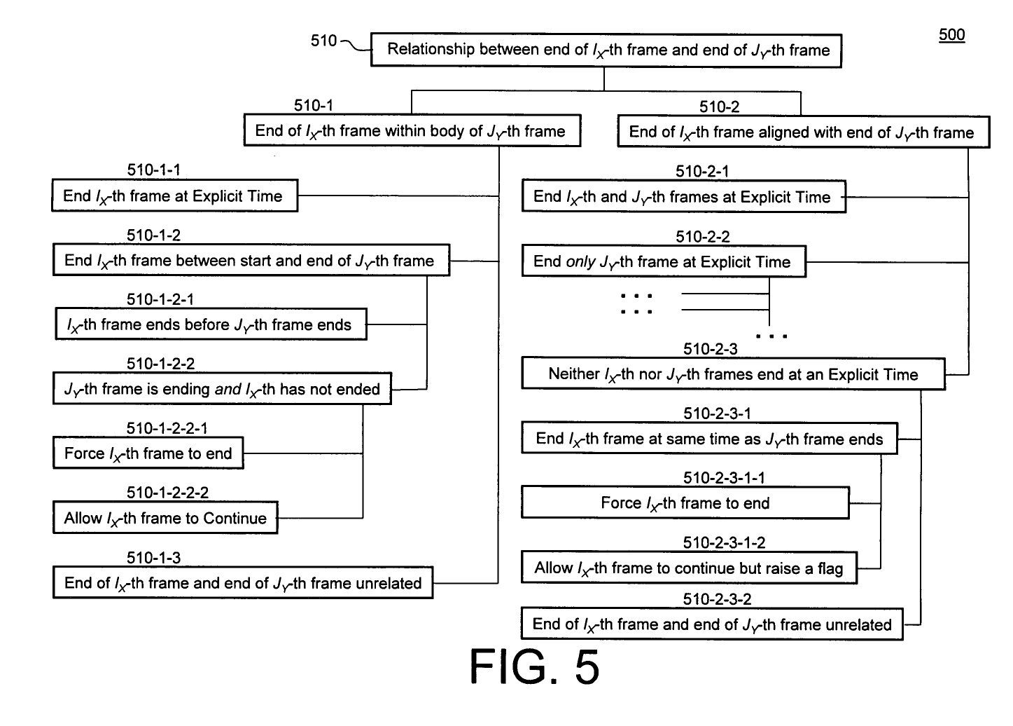

Turning to the second category, FIG. 5 illustrates an option tree 500 for specifying an ending relationship between two frames in the construct of FIG. 3. The trunk 510 of tree 500 is the relationship between the end of an I_{X}-th frame of an X-th frame sequence and the end of a J_{Y}-th frame in a Y-th frame sequence. Each of the branches in FIG. 5 can be viewed as one optional meaning for that relationship.

In FIG. 5, a first upper-level branch 510-1 indicates a case corresponding to a graphical relationship where the end of the I_{X}-th frame of an X-th frame sequence lies between the start time and the end time of a J_{Y}-th frame in a Y-th frame sequence.

In one lower level branch 510-1-1, the I_{X}-th frame is meant to end at an explicit time.

In another lower level branch 510-1-2, the I_{X}-th frame is meant to end between the start of the J_{Y}-th frame and the end of the J_{Y}-th frame.

Within lower level branch 510-1-2, still lower level options are possible for a programmer to specify what should happen under various possible scenarios.

Branch 510-1-2-1 indicates a situation where the I_{X}-th frame ends before the J_{Y}-th frame ends.

Branch 510-1-2-2 indicates a situation where the J_{Y}-th frame is ending, but the I_{X}-th frame is not yet completed. In that case, two meanings are possible.

Branch 510-1-2-2-1 indicates an option wherein it is meant that the I_{X}-th frame should be forced to terminate if it is still running when the J_{Y}-th frame ends.

Branch 510-1-2-2-2 indicates an option wherein it is meant that the I_{X}-th frame is allowed to continue even after the J_{Y}-th frame ends, but perhaps an exception or an error flag should be set.

In still another lower level branch 510-1-3 the end of the I_{X}-th frame falling within the body of the J_{Y}-th frame is a mere happenstance. That is, the end of the I_{X}-th frame is unrelated to the end of the J_{Y}-th frame. For example, the I_{X}-th frame may comprise an operation that is not time-oriented.

A second upper-level branch 510-2 illustrates a case corresponding to a graphical relationship where the end of an I_{X}-th frame of an X-th frame sequence is aligned with an end time of an J_{Y}-th frame in a Y-th frame sequence.

In one lower level branch 510-2-1, both the I_{X}-th frame and the J_{Y}-th frame are meant to end at the same explicit time.

In another lower level branch 510-2-2, only the J_{Y}-th frame is meant to end at an explicit time. In that case, the further options are the same as indicated above with respect to branches 510-1-2 (where the I_{X}-th frame is meant to end anytime between the start of the J_{Y}-th frame and the end of the J_{Y}-th frame) and 510-1-3 (where the alignment of the ends of the I_{X}-th frame and the J_{Y}-th frame is merely happenstance), except that instead of using the actual end time of the J_{Y}-th frame, the explicitly labeled end time is employed.

In still another lower level branch 510-2-3, neither the I_{X}-th frame nor the J_{Y}-th frame is meant to end at any explicit time.

In that case, branch 510-2-3-1 indicates a case where the I_{X}-th frame is meant to end at the same time as the J_{Y}-th frame (where that time is not explicit). In that case: (1) lower level branch 510-2-3-1-1-1 indicates a case where the I_{X}-th frame is forced to end; and (2) lower level branch 510-2-3-1-2 indicates a case where the I_{X}-th frame is allowed to continue, but a flag may be raised.

Meanwhile, branch 510-2-3-2 indicates a case where the alignment of the end of the I_{X}-th frame and the end of the J_{Y}-th frame is a mere happenstance, and there is no constraint between the ends of the I_{X}-th frame and the J_{Y}-th frame.

In one embodiment, syntax is provided for allowing a user to specify any of the semantic choices identified by the branches in FIG. 5. For example, the programming language may allow a programmer to designate the meaning associated with lower level branch 510-2-1 by marking the right edges of the I_{X}-th frame and the J_{Y}-th frame with an explicit time. Alternatively, the programming language may allow a programmer to indicate an explicit start time and a fixed duration for the I_{X}-th frame and the J_{Y}-th frame. Also, one or more of the lower level branches may be designated by default.

Also, in the case of lower level branches 510-1-2, it can be seen from FIG. 3 that the right edge of the I_{X}-th frame may occur within the body of different frames 320 in several of the thread sequences 310. In that case, a programmer is allowed to specify that the J_{Y}-th frame is the intended frame from which the end of the I_{X}-th frame depends.

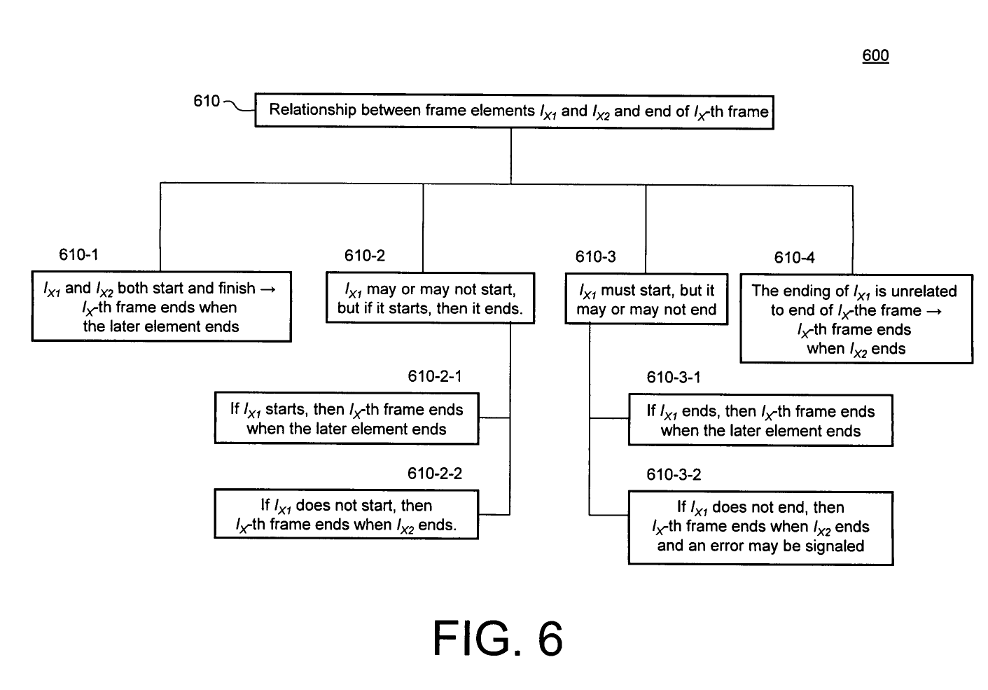

Turning to the third category, FIG. 6 illustrates an option tree 600 for specifying the semantics that should apply to a parallel group of frames or frame elements in the construct of FIG. 3.

Consider the case where an I-th frame includes several frame elements I_{X1} and I_{X2}, (in general, a frame may include frame elements I_{X1}, I_{X2}, . . . I_{Xi}, . . . , I_{XN}) In FIG. 3, when there is no explicit start time specified for the I_{X+1}-th frame, then the graphical representation indicates that the I_{X+1}-th frame is supposed to start when the I_{X}-th frame ends. However, it is not clear what the programmer intends to happen. There are several possibilities, and it would be beneficial to provide syntax for a programmer to select any of these options. It is useful at a high level of abstraction to say this is just “the I_{X}-th frame followed immediately by the I_{X+1}-th frame.” However, another programmer, or the same one thinking at a lower level, might wonder what guarantees the program provides about when the I_{X+1}-th frame starts (i.e. when the I_{X}-th frame ends). The programmer might want to be sure that the I_{X+1}-th frame begins under the right circumstances—when one component of the I_{X}-th frame has finished, another hasn't started but doesn't need to, and a third has started and not ended, but is going to get killed because the first one has finished, etc. So it is important for the programmer to be able to specify the intended semantics for a particular instance of “the I_{X}-th frame followed immediately by the I_{X+1}-th frame.”

In FIG. 6, the trunk 610 of tree 600 is a relationship between frame elements I_{X1} and I_{X2} and the end of the I_{X}-th frame. Branch 610-1 indicates a case where I_{X1} and I_{X2} both start and finish. In this case the I_{X}-th frame ends at the later of their end times—whether or not either or both end times are specified explicitly.

Branch 610-2 indicates a case where I_{X1} may or may not start, but if I_{X1} starts, then it must end. Lower level branch 610-2-1 indicates a case where I_{X1} starts, in which case, the I_{X}-the frame ends at the later of I_{X1}, and I_{X2}. Lower level branch 610-2-2 indicates a case where I_{X1} does not start, in which case the I_{X}-th frame ends when I_{X2} ends.

Branch 610-3 indicates a case where I_{X1} must start, but I_{X1} may or may not end. Lower level branch 610-3-1 indicates a case where I_{X1} ends, in which case, the I_{X}-the frame ends at the later of I_{X1} and I_{X2}. Lower level branch 610-3-2 indicates a case where I_{X1} does not end, in which case the I_{X}-th frame ends when I_{X2} ends.

Branch 610-4 indicates a case where the ending of I_{X1} is unrelated to the end of the I_{X}-the frame, in which case, the I_{X}-th frame ends when I_{X2} ends.

Of course there is nothing special about I_{X1} in FIG. 6, and the roles of I_{X1} and I_{X2} may be reversed. Also, as mentioned above, an I_{X}-th frame may include more than two frame elements.

While example embodiments are disclosed herein, one of ordinary skill in the art appreciates that many variations that are in accordance with the present teachings are possible and remain within the scope of the appended claims. The embodiments therefore are not to be restricted except within the scope of the appended claims.

1. In a computer programming language environment wherein operations are specified in one or more parallel frame sequences of frames arranged on a time scale, a method comprising:
providing user-specified semantics for defining the start times for starting the frames and for defining the end times for ending the frames; and
executing the operations according to the start times and end times for the frames as defined by the user-specified semantics.

2. The method of claim 1, wherein the user-specified semantics define a start time of an I_{X}-th frame of an X-th frame sequence with respect to a J_{Y}-th frame in a Y-th frame sequence.

3. The method of claim 2, wherein the user-specified semantics define the start time of the I_{X}-th frame in a case where the I_{X}-th frame is to start after the J_{Y}-th frame starts and before the J_{Y}-th frame ends.

4. The method of claim 3, wherein the user-specified semantics define the start time of the I_{X}-th frame as an explicit time.

5. The method of claim 3, wherein the user-specified semantics define a start time of the I_{X}-th frame as occurring at a first triggering event after the J_{Y}-th frame starts.

6. The method of claim 3, wherein the user-specified semantics define a start time of the I_{X}-th frame as occurring at any triggering event after the J_{Y}-th frame starts.

7. The method of claim 1, wherein the user-specified semantics define an end time of an I_{X}-th frame of an X-th frame sequence with respect to a J_{Y}-th frame in a Y-th frame sequence.

8. The method of claim 7, wherein the user-specified semantics define the end time of the I_{X}-th frame in a case where an ending of the I_{X}-th frame occurs between a start of the J_{Y}-th frame and an end of the J_{Y}-th frame.

9. The method of claim 8, wherein the user-specified semantics define what to do in a condition where the J_{Y}-th frame is ending and the I_{X}-th frame has not yet ended.

10. The method of claim 8, wherein the user-specified semantics define the end time of the I_{X}-th frame as an explicit time.

11. The method of claim 7, wherein the user-specified semantics define the end of the I_{X}-th frame in a case where an ending of the I_{X}-th frame is aligned with an ending of the J_{Y}-th frame.

12. The method of claim 11, wherein the user-specified semantics define what to do in a condition where the J_{Y}-th frame is ending and the I_{X}-th frame has not yet ended.

13. The method of claim 11, wherein the user-specified semantics define the end time of the I_{X}-th frame as an explicit time.

14. The method of claim 1, wherein at least an I_{X}-th frame includes a plurality of frame elements, and wherein the user-specified semantics define an end time of the I_{X}-th frame with respect to the frame elements of the I_{X}-th frame.

15. The method of claim 14, wherein the user-specified semantics define the start time of an I_{X+1}-th frame that follows the I_{X}-th frame in terms of the end times of the frame elements of the I_{X}-th frame.

16. A computer-based system, comprising:
memory; and
a processor configured to execute one or more algorithms in response to instructions stored in the memory and written using a programming language, the programming language further providing a plurality of available user-specifiable semantics for defining start times for starting the frames and for defining end times for ending the frames, wherein the processor executes the operations according to start times and end times for the frames as defined by selected ones of the available user-specifiable semantics specified by a user.

17. The system of claim 16, wherein the available user-specifiable semantics for defining the start times for starting the frames include user-specifiable semantics for defining a start time of an I_{X}-th frame of an X-th frame sequence with respect to a start time of an J_{Y}-th frame in a Y-th frame sequence.

18. The system of claim 16, wherein the available user-specifiable semantics for defining the end time for ending the frames include user-specifiable semantics for defining an end time of an I_{X}-th frame of an X-th frame sequence with respect to a J_{Y}-th frame in a Y-th frame sequence.

19. The system of claim 16, wherein at least an I_{X}-th frame includes a plurality of frame elements, and wherein the available user-specifiable semantics include user-specifiable semantics for defining an end time for the I_{X}-th frame in terms of the frame elements of the I_{X}-th frame.

20. The system of claim 19, the available user-specifiable semantics further include user-specifiable semantics for defining the start time of an I_{X+1}-th frame that follows the I_{X}-th frame in terms of the frame elements of the I_{X}-th frame.
